(19) United States
(12) Patent Application Publication
(10) Pub. No.: US 2024/0204543 A1
(43) Pub. Date: Jun. 20, 2024

(54) POWER CONTROL APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Yusuke ISAJI, Osaka-shi, Osaka (JP)

(21) Appl. No.: 18/556,431

(22) PCT Filed: Mar. 22, 2022
(86) PCT No.: PCT/JP2022/013056

§ 371 Date: Oct. 20, 2023

(30) Foreign Application Priority Data
Apr. 21, 2021 (JP) 2021-071743

(51) Int. Cl. H02J 7/00; H01M 50/204; H01M 50/269; H01M 50/507

(52) U.S. Cl. CPC H02J 7/0024; H01M 50/204; H01M 50/269; H01M 50/507; H02J 7/0042; H02J 7/0063

(57) ABSTRACT

A power control apparatus is connected to a high-voltage battery constructed by connecting a plurality of cell units. In the power control apparatus, an electrical connection unit for connecting the high-voltage battery and a load and a series-parallel switching unit that is connected to the plurality of cell units and the electrical connection unit and switches a connection between the plurality of cell units between series and parallel are integrated.

### CROSS-REFERENCE TO RELATED APPLICATIONS

This application is the U.S. national stage of PCT/JP2022/013056 filed on Mar. 22, 2022, which claims priority of Japanese Patent Application No. JP 2021-071743 filed on Apr. 21, 2021, the contents of which are incorporated herein.

### TECHNICAL FIELD

The present disclosure relates to a power control apparatus.

### BACKGROUND

Power supplying apparatuses installed in electric vehicles, hybrid vehicles, and the like are conventionally known. As one example, the power supplying apparatus described in JP2007-274830A includes first and second power storage means that are electrically connected to an inverter, first switching means disposed in a circuit for connecting the first power storage means and the second power storage means in series to an inverter, and second switching means disposed in a circuit for connecting the first power storage means and the second power storage means in parallel to the inverter.

When incorporating a circuit for switching the connection between the first and second storage means between series and parallel as described above into the circuit connecting the inverter and the first and second storage means, there are cases where the size of the power supplying apparatus becomes large and the number of man-hours for connecting wiring increases.

### SUMMARY

A power control apparatus according to an aspect of the present disclosure is connected to a high-voltage battery constructed by connecting a plurality of cell units, the power control apparatus including: an electrical connection unit for connecting the high voltage battery and a load; and a series-parallel switching unit that is connected to the plurality of cell units and the electrical connection unit and switches a connection between the plurality of cell units between series and parallel, wherein the electrical connection unit and the series-parallel switching unit are integrated.

### Advantageous Effects

According to the present disclosure, it is possible to provide a power control apparatus capable of miniaturization and a reduction in man-hours for connection work.

### BRIEF DESCRIPTION OF DRAWINGS

FIG. 1 is a plan view of a power control apparatus according to a first embodiment.

FIG. 2 is a perspective view of a bus bar including an intermediate potential connecting portion on a third conductive path.

FIG. 3 is a perspective view of a bus bar including an intermediate potential connecting portion on a fourth conductive path.

FIG. 4 is a circuit diagram of a power control apparatus.

FIG. 5 is a plan view of a power control apparatus according to a second embodiment.

FIG. 6 is a plan view of an electrical connection unit.

FIG. 7 is a plan view of a series-parallel switching unit.

FIG. 8 is a perspective view of a state where an electrical connection unit and a series-parallel switching unit have been separated in a stacking direction.

FIG. 9 is a cross-sectional view along a line A-A in FIG. 5.

FIG. 10 is a circuit diagram of a power control apparatus.

### DETAILED DESCRIPTION OF PREFERRED EMBODIMENTS

Modes for carrying out the present disclosure will first be listed and described in outline.

A power control apparatus according to the present disclosure is connected to a high-voltage battery constructed by connecting a plurality of cell units, the power control apparatus including: an electrical connection unit configured to connect the high voltage battery and a load; and a series-parallel switching unit that is connected to the plurality of cell units and the electrical connection unit and is configured to switch a connection between the plurality of cell units between series and parallel, wherein the electrical connection unit and the series-parallel switching unit are integrated.

By using the above configuration, wiring that connects the electrical connection unit and the series-parallel switching unit becomes unnecessary, which makes it possible to reduce the man-hours taken to connect the electrical connection unit and the series-parallel switching unit. Also, since the electrical connection unit and the series-parallel switching unit are integrated, downsizing of the power control apparatus is facilitated.

The power control apparatus described above preferably includes a connecting bus bar for connecting the electrical connection unit and the series-parallel switching unit.

By using the above configuration, it is possible to connect the electrical connection unit and the series-parallel switching unit more easily compared to when electric wires or the like are used.

The power control apparatus described above may further include a single base member made of insulating resin, and the electrical connection unit and the series-parallel switching unit may be integrally formed on the base member.

By using the above configuration, since the electrical connection unit and the series-parallel switching unit are integrally provided on the same base member, it is easy to reduce the height of the power control apparatus.

The electrical connection unit and the series-parallel switching unit may be separately formed and capable of being stacked.

By using the above configuration, it is possible to reduce the area occupied by the power control apparatus, that is, the area on a plane that is perpendicular to the axis in which the stacking direction of the electrical connection unit and the series-parallel switching unit extends. It is possible to install the electrical connection unit and the series-parallel switching unit in a vehicle or the like in a stacked state and also possible to separate only the electrical connection unit and install the electrical connection unit in a vehicle or the like.

It is preferable for the series-parallel switching unit to be stacked on the electrical connection unit, for cutaway portions to be formed in a base member, which is made of insulating resin and constructs the series-parallel switching unit, and for the electrical connection unit to include a load connecting portion for connecting to the load, a main positive electrode connecting portion for connecting to a main positive electrode of the high-voltage battery, and a main negative electrode connecting portion for connecting to a main negative electrode of the high-voltage battery, and for the main positive electrode connecting portion, the main negative electrode connecting portion, and the load connecting portion to be disposed inside the cutaway portions.

By using the above configuration, the connecting of the power control apparatus and the high-voltage battery and the connecting of the power control apparatus and the load can be performed after the electrical connection unit and the series-parallel switching unit have been stacked.

It is preferable for the electrical connection unit described above to include a load connecting portion for connecting to the load, a main positive electrode connecting portion for connecting to a main positive electrode of the high-voltage battery, and a main negative electrode connecting portion for connecting to a main negative electrode of the high-voltage battery, for the series-parallel switching unit to include a plurality of intermediate potential connecting portions to which electrode terminals of the plurality of cell units that are not the main positive electrode and the main negative electrode are connected, for the load connecting portion to be disposed on an opposite side to the main positive electrode connecting portion, the main negative electrode connecting portion, and the plurality of intermediate potential connecting portions, and for the plurality of intermediate potential connecting portions to be disposed between the main positive electrode connecting portion and the main negative electrode connecting portion.

By using the above configuration, it is easy to dispose the power control apparatus between the high-voltage battery and the load. In addition, incorrect assembly of the power control apparatus and the high-voltage battery, or of the power control apparatus and the load, can be suppressed.

Specific embodiments of the present disclosure will now be described. Note that the present disclosure is not limited to the illustrated configurations and is instead indicated by the range of the patent claims and intended to include all changes within the meaning and scope of the patent claims and their equivalents.

### First Embodiment

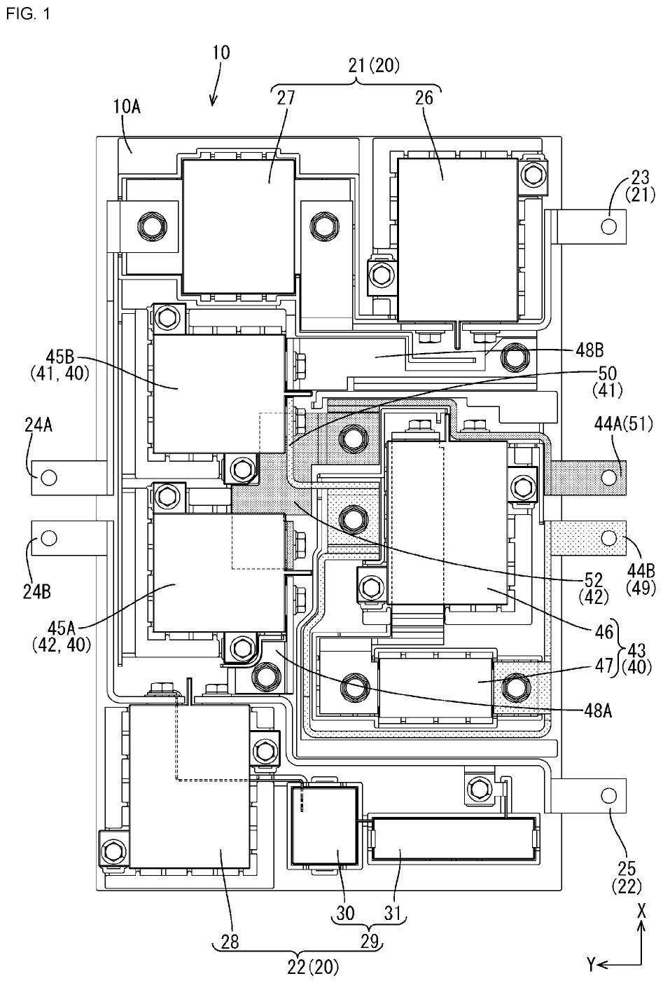

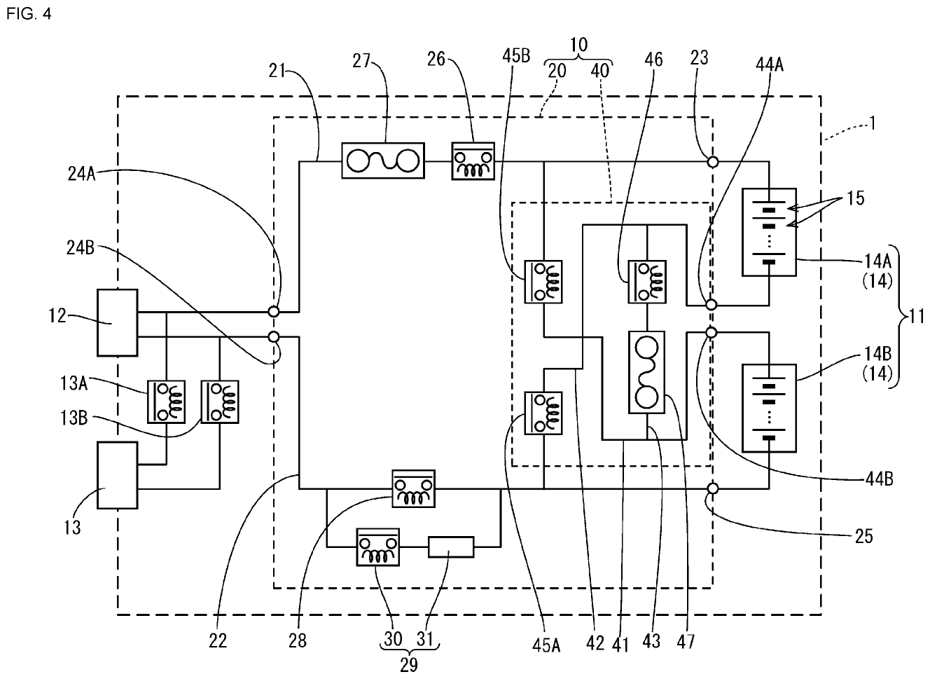

A first embodiment of the present disclosure will now be described with reference to FIGS. 1 to 4. In the following description, aside from FIG. 4, the direction indicated by arrow X is forward, the direction indicated by arrow Y is left, and the direction indicated by arrow Z is upward. After a power control apparatus 10 has been described using the circuit diagram in FIG. 4, detailed configurations will be described with reference to FIGS. 1 to 3. In this description, out of a plurality of members that are the same, only some members have been assigned reference numerals and the reference numerals of other members may be omitted.

As depicted in FIG. 4, the power control apparatus 10 according to the present embodiment is disposed inside a battery pack 1 that is installed in a vehicle, such as an electric vehicle or a hybrid vehicle, and connects between a high-voltage battery 11 and a load (not illustrated).

As depicted in FIG. 4, the battery pack 1 is equipped with the power control apparatus 10, the high-voltage battery 11, a power supplying connector 12, a rapid charging connector 13, and the like. The high-voltage battery 11 is connected to the power supplying connector 12 via the power control apparatus 10. The power supplying connector 12 is designed to be connected to loads, such as various electronic devices. The rapid charging connector 13 is provided on a branch from a conductive path that connects the power control apparatus 10 and the power supplying connector 12. Rapid charging relays 13A and 13B are provided on conductive paths that connect the rapid charging connector 13 and the power control apparatus 10. The rapid charging relays 13A and 13B are both switched according to a signal from a power supplying control unit, not illustrated, to one of a conductive (or “on”) state and an open (or “off”) state.

### High-Voltage Battery and Cell Units

As depicted in FIG. 4, the battery pack 1 includes the high-voltage battery 11 that is equipped with a plurality of cell units 14. This plurality of cell units 14 in the present embodiment is composed of a cell unit 14A and a cell unit 14B. Out of the pair of electrode terminals provided at the respective ends of the cell unit 14A, the positive electrode terminal disposed on the upper side in the drawing serves as a main positive electrode of the high-voltage battery 11. Out of the pair of electrode terminals provided at the respective ends of the cell unit 14B, the negative electrode terminal disposed on the lower side in the drawing serves as the main negative electrode of the high-voltage battery 11. Here, the expressions “main positive electrode” and “main negative electrode” refer to the positive and negative external connection terminals of the high-voltage battery 11. Each of the cell units 14A and 14B is configured by connecting an equal number of storage elements 15 in series. As one example, lithium ion cells can be used as the storage elements 15.

The high-voltage battery 11 is used as a driving source of a vehicle and outputs a high voltage. As one example, the voltages of the cell units 14A and 14B in the present embodiment are 400 V the voltage of the high-voltage battery 11 when the plurality of cell units 14 are connected in series is 800 V and the voltage when the plurality of cell units 14 are connected in parallel is 400V.

### Power Control Apparatus

As depicted in FIG. 4, the power control apparatus 10 includes an electrical connection unit 20, which connects the high-voltage battery 11 and a load, and a series-parallel switching unit 40 that switches the connection between the plurality of cell units 14 between connection in series and connection in parallel. As depicted in FIG. 1, in the power control apparatus 10 according to this embodiment, the electrical connection unit 20 and the series-parallel switching unit 40 are integrally formed on a single base member 10A. The base member 10A is a board-like member made of an electrically insulating synthetic resin. Although not illustrated in detail, the base member 10A has bolt fastening portions to which bolts can be fastened, and attachment grooves to which electronic components (such as relays and fuses) that construct the power control apparatus 10 and bus bars are attached. Such electronic components and bus bars are electrically connected and fixed to the base member 10A by bolting. In FIG. 1, the outlines of the bus bars disposed below the electronic components are indicated by dashed lines.

### Electrical Connection Unit

As depicted in FIG. 4, the electrical connection unit 20 is equipped with a first conductive path 21 that connects the main positive electrode of the high-voltage battery 11 and the load, and a second conductive path 22 that connects the main negative electrode of the high-voltage battery 11 and the load. One end of the first conductive path 21 connected to the main positive electrode of the high-voltage battery 11 serves as a “main positive electrode connecting portion 23”. The other end of the first conductive path 21 connected to the load is a “load connecting portion 24A”. One end of the second conductive path 22 connected to the main negative electrode of the high-voltage battery 11 serves as a “main negative electrode connecting portion 25”. The other end of the second conductive path 22 connected to the load is a “load connecting portion 24B”.

As depicted in FIG. 4, a first system main relay 26 and a main fuse 27 are connected in series to the first conductive path 21. The main fuse 27 blocks overcurrents by opening the first conductive path 21 when an overcurrent flows on the first conductive path 21. The first system main relay 26 is switched between on and off by a signal from a power supplying control unit (not illustrated). The first conductive path 21 is branched at a position between the first system main relay 26 and the main positive terminal connecting portion 23, and is connected to a third conductive path 41, described later.

As depicted in FIG. 4, the second conductive path 22 is provided with a second system main relay 28. A precharge circuit 29 is connected in parallel to this second system main relay 28. The precharge circuit 29 includes a precharge relay 30 and a precharge resistor 31 that are connected in series. The second system main relay 28 and the precharge relay 30 are switched between on and off by a signal from a power supplying control unit (not illustrated). When the high-voltage battery 11 is charged, the second system main relay 28 is turned on after the precharge relay 30 has first been turned on, which prevents a rush current from flowing through the second system main relay 28. The second conductive path 22 is branched at a position between the second system main relay 28 and the main negative electrode connecting portion 25, and is connected to a fourth conductive path 42, described later.

As depicted in FIG. 1, the first conductive path 21 is provided on the front side (at the top in the drawing) of the base member 10A, and is equipped with the first system main relay 26 and the main fuse 27. The first system main relay 26 is disposed at the front and on the right on the base member 10A and the main fuse 27 is disposed at the front and on the left on the base member 10A. The main positive electrode connecting portion 23, which is disposed at a right end of the first conductive path 21, protrudes rightward from a front-right outer edge of the base member 10A. The load connecting portion 24A, which is disposed at a left end of the first conductive path 21, protrudes leftward from the outer edge of the base member 10A near the center in the front-rear direction.

As depicted in FIG. 1, the second conductive path 22 is provided to the rear (below in the drawing) of the base member 10A, and is equipped with the second system main relay 28 and the precharge circuit 29. The precharge circuit 29 includes the precharge relay 30 and the precharge resistor 31. The second system main relay 28 is disposed at the rear and on the left of the base member 10A and the precharge circuit 29 is disposed at the rear and on the right of the base member 10A. The main negative electrode connecting portion 25, which is disposed at the right end of the second conductive path 22, protrudes rightward from a rear-right outer edge of the base member 10A. The load connecting portion 24B, which is disposed at the left end of the second conductive path 22, protrudes leftward from the outer edge of the base member 10A near the center in the front-rear direction.

### Serial-Parallel Switching Unit

As depicted in FIG. 4, the series-parallel switching unit 40 includes the third conductive path 41 that connects the first conductive path 21 and the cell unit 14B, the fourth conductive path 42 that connects the second conductive path 22 and the cell unit 14A, and a fifth conductive path 43 that connects the third conductive path 41 and the fourth conductive path 42. The end of the third conductive path 41 connected to the cell unit 14B serves as an “intermediate potential connecting portion 44B”. The end of the fourth conductive path 42 connected to the cell unit 14A serves as an “intermediate potential connecting portion 44A”.

As depicted in FIG. 4, the intermediate potential connecting portion 44B of the third conductive path 41 is connected to the positive terminal of the cell unit 14B, which is disposed at the upper side of the cell unit 14B in the drawing. Here, the positive electrode terminal of the cell unit 14B is one example of an electrode terminal of the plurality of cell units 14 that is not the main positive electrode or the main negative electrode of the high-voltage battery 11. That is, the negative electrode terminal of the cell unit 14B that forms a pair with this positive electrode terminal serves as the main negative electrode of the high-voltage battery 11. The end of the third conductive path 41 on the opposite side to the intermediate potential connecting portion 44B is connected to the first conductive path 21 at a position between the first system main relay 26 and the main positive electrode connecting portion 23. The third conductive path 41 is provided with a second relay 45B.

As depicted in FIG. 4, the intermediate potential connecting portion 44A of the fourth conductive path 42 is connected to the negative terminal of the cell unit 14A, which is disposed at the lower side of the cell unit 14A in the drawing. Here, the negative terminal of the cell unit 14A is one example of an electrode terminal of the plurality of cell units 14 that is not the main positive electrode or the main negative electrode of the high-voltage battery 11. That is, the positive terminal of the cell unit 14A that forms a pair with this negative terminal serves as the main positive electrode of the high-voltage battery 11. The end of the fourth conductive path 42 on the opposite side to the intermediate potential connecting portion 44A is connected to the second conductive path 22 at a position between the second system main relay 28 and the main negative electrode connecting portion 25. The fourth conductive path 42 is provided with a second relay 45A.

As depicted in FIG. 4, the fifth conductive path 43 connects the intermediate potential connecting portions 44A and 44B in series. In more detail, the fifth conductive path 43 is provided so as to be branched from the third conductive path 41 at a position between the second relay 45B and the intermediate potential connecting portion 44B and from the fourth conductive path 42 at a position between the second relay 45A and the intermediate potential connecting portion 44A. A first relay 46 and a first fuse 47 are provided on this fifth conductive path 43. The first fuse 47 blocks overcurrents by opening the fifth conductive path 43 when an overcurrent flows on the fifth conductive path 43.

The first relay 46 and the second relays 45A and 45B are switched to either an on or off state according to signals from a power supplying control unit (not depicted). As depicted in FIG. 4, when the first relay 46 is turned on and the second relays 45A and 45B are turned off, the plurality of cell units 14 can be connected in series to the electrical connection unit 20. On the other hand, when the first relay 46 is turned off and the second relays 45A and 45B are turned on, the plurality of cell units 14 can be connected in parallel to the electrical connection unit 20.

Accordingly, it is possible to switch the connection between the plurality of cell units 14 between series and parallel in keeping with the voltage of a rapid charger (not depicted) connected to the rapid charging connector 13 and/or the voltage required by the load connected to the power supplying connector 12, which means that the voltage of the high-voltage battery 11 can be changed as appropriate. As one example, since the individual voltages of the cell units 14A and 14B in the present embodiment are 400V, when the high-voltage battery 11 is charged using a 400V rapid charger, the plurality of cell units 14 can be connected in parallel, and when the high-voltage battery 11 is charged using an 800V rapid charger, the plurality of cell units 14 can be connected in series.

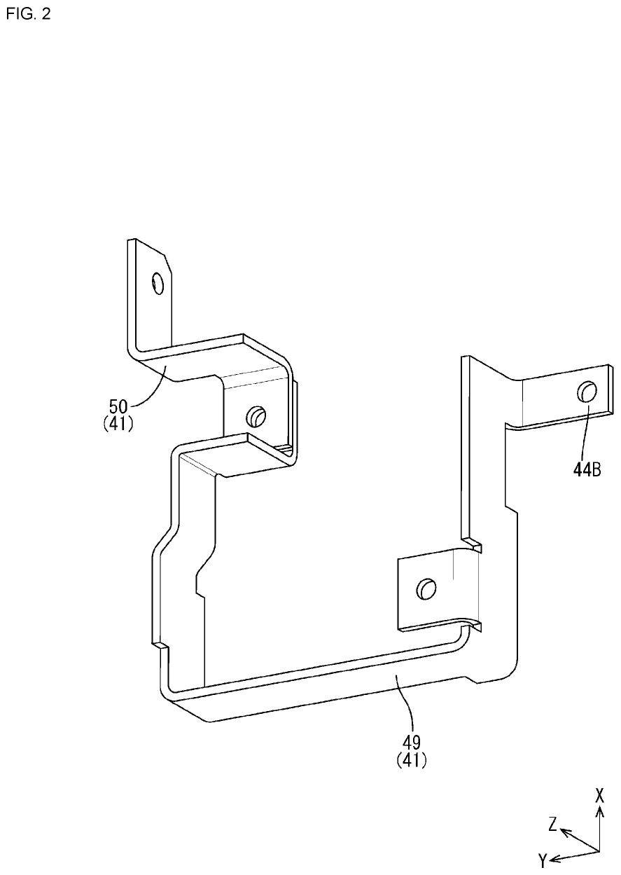

As depicted in FIG. 1, the series-parallel switching unit 40 (that is, the third conductive path 41, the fourth conductive path 42, and the fifth conductive path 43) is disposed between the first conductive path 21 and the second conductive path 22 in the front-rear direction. The third conductive path 41 is provided with the second relay 45B that is disposed to the rear of the main fuse 27. A bus bar that extends rightward from the second relay 45B serves as a “connection bus bar 48B”. This connection bus bar 48B connects the second relay 45B and a bus bar including the main positive electrode connecting portion 23 of the first conductive path 21. The end of the third conductive path 41 at the opposite end to the connection bus bar 48B serves as the “intermediate potential connecting portion 44B”. The intermediate potential connecting portion 44B protrudes rightward from the outer edge of the base member 10A near the center in the front-rear direction. The third conductive path 41 between the intermediate potential connecting portion 44B and the second relay 45B is indicated by light shading. As depicted in FIG. 2, this lightly shaded portion is composed of the gate-shaped first bus bar 49, which includes the intermediate potential connecting portion 44B, and a second bus bar 50 connected to the upper left end of the first bus bar 49.

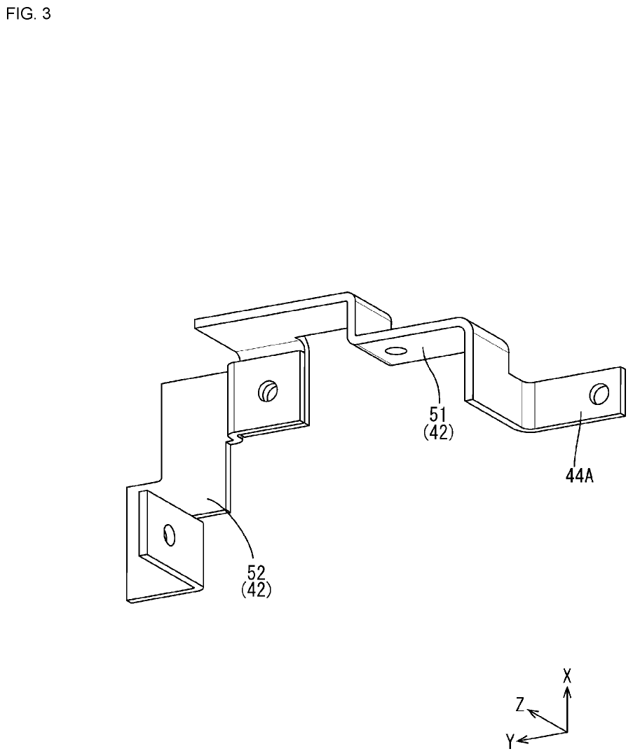

As depicted in FIG. 1, the fourth conductive path 42 includes a second relay 45A disposed to the rear of the second relay 45B. A bus bar extending rearward from the second relay 45A serves as a “connection bus bar 48A”. This connection bus bar 48A connects the second relay 45A and a bus bar including the main negative electrode connecting portion 25 of the second conductive path 22. The end of the fourth conductive path 42 at the opposite end to the connection bus bar 48A serves as the intermediate potential connecting portion 44A. The intermediate potential connecting portion 44A protrudes rightward from the outer edge of the base member 10A near the center in the front-rear direction. The fourth conductive path 42 between the second relay 45A and the intermediate potential connecting portion 44A is indicated by darker shading. As depicted in FIG. 3, the darkly shaded portion is composed of a third bus bar 51, which includes the intermediate potential connecting portion 44A, and a fourth bus bar 52 connected to the left end of the third bus bar 51. As depicted in FIG. 1, the fourth bus bar 52 is disposed below the second bus bar 50 of the third conductive path 41.

As depicted in FIG. 1, the fifth conductive path 43 includes the first relay 46 and the first fuse 47 disposed to the rear the first relay 46. The first relay 46 and the first fuse 47 are disposed so as to be surrounded by the first bus bar 49 and a second bus bar 50 indicated by the light shading and the third bus bar 51 and the fourth bus bar 52 indicated by the dark shading.

Conventionally when using a power control apparatus in which the electrical connection unit and the series-parallel switching unit are not integrated, the electrical connection unit and the series-parallel switching unit are separately disposed in a battery pack and it is necessary to connect the electrical connection unit and the series-parallel switching unit using a wire harness. With the power control apparatus 10 according to the present embodiment however, as depicted in FIG. 1, the electrical connection unit 20 and the series/parallel switching unit 40 are integrated and connected in advance by the connection bus bars 48A and 48B. Accordingly, it is possible to reduce the man-hours taken by connecting the power control apparatus 10 to the high-voltage battery 11 and the load, and to downsize the power control apparatus 10.

As depicted in FIG. 1, the electronic components and bus bars that construct the electrical connection unit 20 and the series-parallel switching unit 40 are fixed to the same base member 10A by bolting, which integrally forms the power control apparatus 10. Accordingly, it is possible to reduce the vertical dimension of the power control apparatus 10 in particular (that is, the direction perpendicular to the plane of FIG. 1), which can lead to a reduction in height of the power control apparatus 10.

As depicted in FIG. 1, the main positive electrode connecting portion 23, the main negative electrode connecting portion 25, and the intermediate potential connecting portions 44A and 44B, which are connected to the high-voltage battery 11 are disposed on the right side of the power control apparatus 10, with the intermediate potential connecting portions 44A and 44B disposed between the main positive electrode connecting portion 23 and the main negative electrode connecting portion 25. The load connecting portions 24A and 24B to be connected to the load are disposed on the left side of the power control apparatus 10. Accordingly, it becomes easier to dispose the power control apparatus 10 between the high-voltage battery 11 and the load. In addition, incorrect assembly of the power control apparatus 10 and the high-voltage battery 11, or of the power control apparatus 10 and the load, can be suppressed.

As depicted in FIG. 1, the second bus bar 50 of the third conductive path 41 and the fourth bus bar 52 of the fourth conductive path 42 are disposed so as to be displaced in the vertical direction and cross each other in a non-contacting state. That is, the second bus bar 50 and the fourth bus bar 52 cross each other three-dimensionally. When the third conductive path 41 and the fourth conductive path 42 are disposed in this way as depicted in FIG. 4, it is not necessary for the wiring between the cell unit 14A and the intermediate potential connecting portion 44A and the wiring between the cell unit 14B and the intermediate potential connecting portion 44B to cross. Accordingly, it is easy to connect the plurality of cell units 14 and the intermediate potential connecting portions 44A and 44B. On the other hand, if the third conductive path and the fourth conductive path did not cross each other three dimensionally in the series-parallel switching unit, it would be necessary for the wirings between the plurality of cell units and the intermediate potential connecting portions to cross, which would make it complicated to connect the plurality of cell units and the intermediate potential connecting portions.

### Functions and Effects of First Embodiment

According to the first embodiment, the following functions and effects are obtained.

The power control apparatus 10 according to the first embodiment is a power control apparatus 10 that is connected to a high-voltage battery 11 constructed by connecting a plurality of cell units 14. In this power control apparatus 10, an electrical connection unit 20, which connects the high-voltage battery 11 and a load, and a series-parallel switching unit 40, which is connected to the plurality of cell units 14 and the electrical connection unit 20 and switches the connection between the plurality of cell units 14 between series and parallel, are integrated.

According to the above configuration, since wiring for connecting the electrical connection unit 20 and the series-parallel switching unit 40 is unnecessary, it is possible to reduce the man-hours taken by connecting the electrical connection unit 20 and the series-parallel switching unit 40. Since the electrical connection unit 20 and the series/parallel switching unit 40 are integrated, downsizing of the power control apparatus 10 is also facilitated.

The power control apparatus 10 according to the first embodiment includes the connection bus bars 48A and 48B that connect the electrical connection unit 20 and the series-parallel switching unit 40.

According to the above configuration, the electrical connection unit 20 and the series-parallel switching unit 40 can be easily connected compared to a case where electric wires or the like are used.

The power control apparatus 10 according to the first embodiment includes a single base member 10A made of insulating resin, with the electrical connection unit 20 and the series-parallel switching unit 40 being integrally formed on this base member 10A.

According to the above configuration, since the electrical connection unit 20 and the series/parallel switching unit 40 are integrally provided on the same base member 10A, reducing the height of the power control apparatus 10 is facilitated.

In the first embodiment, the electrical connection unit 20 includes the load connecting portions 24A and 24B that are connected to a load, the main positive electrode connecting portion 23 that is connected to the main positive electrode of the high-voltage battery 11, and the main negative electrode connecting portion 25 that is connected to the main negative electrode of the high-voltage battery 11, the series-parallel switching unit 40 includes a plurality of intermediate potential connecting portions 44A and 44B that are connected to electrode terminals of the plurality of cell units 14 that are not the main positive electrode and the main negative electrode, the load connecting portions 24A and 24B are disposed on an opposite side to the main positive electrode connecting portion 23, the main negative electrode connecting portion 25, and the plurality of intermediate potential connecting portions 44A and 44B, and the intermediate potential connecting portions 44A and 44B are disposed between the main positive electrode connecting portion 23 and the main negative electrode connecting portion 25.

With this configuration, it is easy to dispose the power control apparatus 10 between the high-voltage battery 11 and the load. In addition, incorrect assembly of the power control apparatus 10 and the high-voltage battery 11 or of the power control apparatus 10 and the load can be suppressed.

### Second Embodiment

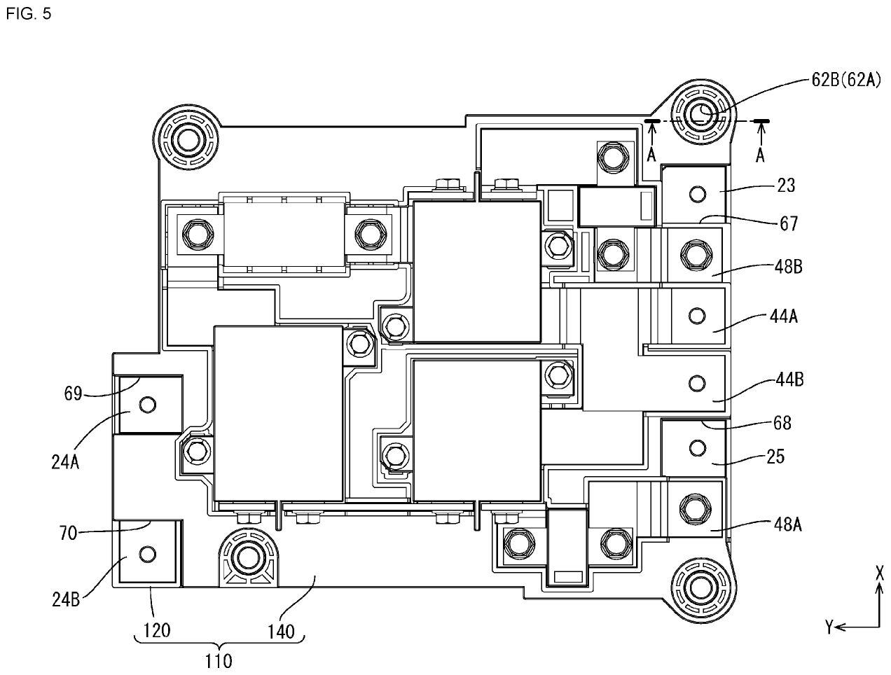

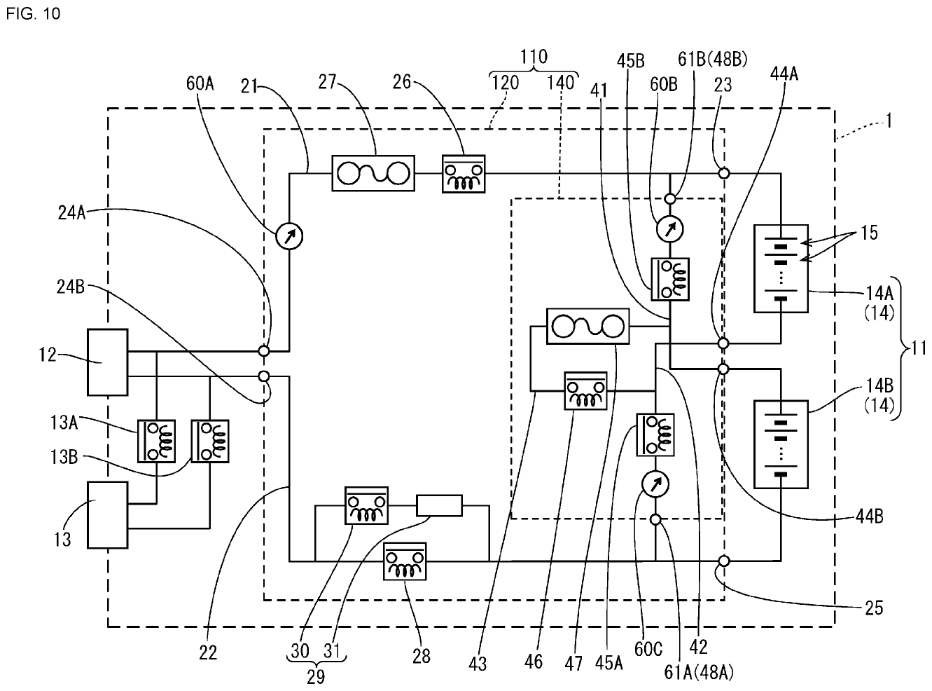

A second embodiment of the present disclosure will now be described with reference to FIG. 5 to FIG. 10. In the following description, aside from FIG. 10, the direction indicated by arrow X is forward, the direction indicated by arrow Y is left, and the direction indicated by arrow Z is upward. After a power control apparatus 110 has been described using the circuit diagram in FIG. 10, the detailed configurations will be described using FIG. 5 to FIG. 9. Out of a plurality of members that are the same, only some members have been assigned reference numerals, and the reference numerals of other members may be omitted. The configuration of the power control apparatus 110 according to the second embodiment is substantially the same as the first embodiment, aside from an electrical connection unit 120 and a series-parallel switching unit 140 being provided separately. Hereinafter, members that are the same as those of the first embodiment have been assigned the same reference numerals as in the first embodiment, and description of the same configurations and effects as the first embodiment is omitted.

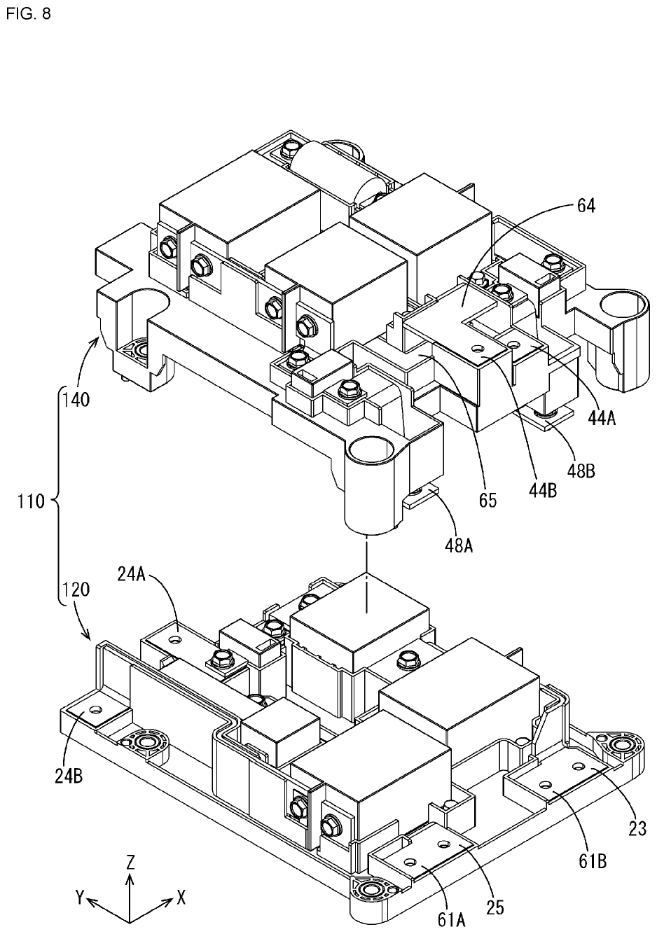

As depicted in FIG. 8, the electrical connection unit 120 and the series-parallel switching unit 140 of the present embodiment are formed separately with it being possible to stack the series-parallel switching unit 140 on top of the electrical connection unit 120. By using this stacked structure, it is possible to reduce the area occupied by the power control apparatus 110 in the battery pack 1. Here, the expression “area occupied by the power control apparatus 110” refers to the area on a plane (that is, a plane that extends in the front-rear direction and the left-right direction) that is perpendicular to an axis that extends in the direction (that is, the vertical direction) in which the electrical connection unit 120 and the series-parallel switching unit 140 are stacked.

Although described in detail later, as depicted in FIG. 8, the connection bus bars 48A and 48B of the series-parallel switching unit 140 are connected to connecting portions 61A and 61B of the electrical connection unit 120, respectively. In other words, in a state where the connection bus bars 48A and 48B and the connecting portions 61A, 61B are not connected, the series-parallel switching unit 140 and the electrical connection unit 120 are separated. Note that the electrical connection unit 120 in this separated state can also be installed on its own in a vehicle or the like as a junction box, for example.

As depicted in FIG. 10, although the circuit diagram of the power control apparatus 110 according to the second embodiment is substantially the same as the circuit diagram of the power control apparatus 10 of the first embodiment (see FIG. 4), current sensors 60A, 60B, and 60C are provided on the first conductive path 21, the third conductive path 41, and the fourth conductive path 42, respectively, of the second embodiment. The current sensors 60A, 60B, and 60C output current values of the conductive paths 21, 41, and 42, with these current values being transmitted to a power control unit (not illustrated). Also, the electrical connection unit 120 and the series-parallel switching unit 140 are connected at the connecting portion 61A (the connection bus bar 48A) and the connecting portion 61B (the connection bus bar 48B).

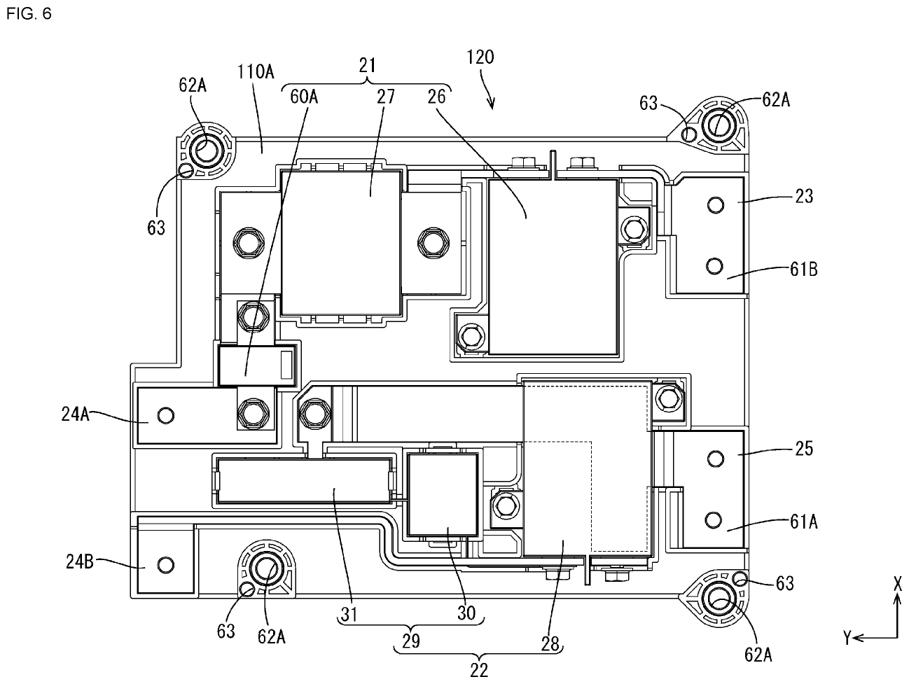

As depicted in FIG. 6, the electrical connection unit 120 is configured by disposing electronic components and bus bars on a base member 110A. The first conductive path 21 is provided so as to extend in the left-right direction on the front side of the base member 110A. The first conductive path 21 includes the first system main relay 26, the main fuse 27, and the current sensor 60A. The main positive electrode connecting portion 23 and the connecting portion 61B located to the rear of the main positive electrode connecting portion 23 are provided at the right end of the first conductive path 21. A load connecting portion 24A is provided at the left end of the first conductive path 21.

As depicted in FIG. 6, a second conductive path 22 is provided so as to extend in the left-right direction on the rear side of the base member 110A. The second conductive path 22 includes the second system main relay 28 and the precharge circuit 29 (the precharge relay 30 and the precharge resistor 31). The main negative electrode connecting portion 25 and the connecting portion 61A located to the rear of the main negative electrode connecting portion 25 are provided at the right end of the second conductive path 22. The load connecting portion 24B is provided at the left end of the first conductive path 22.

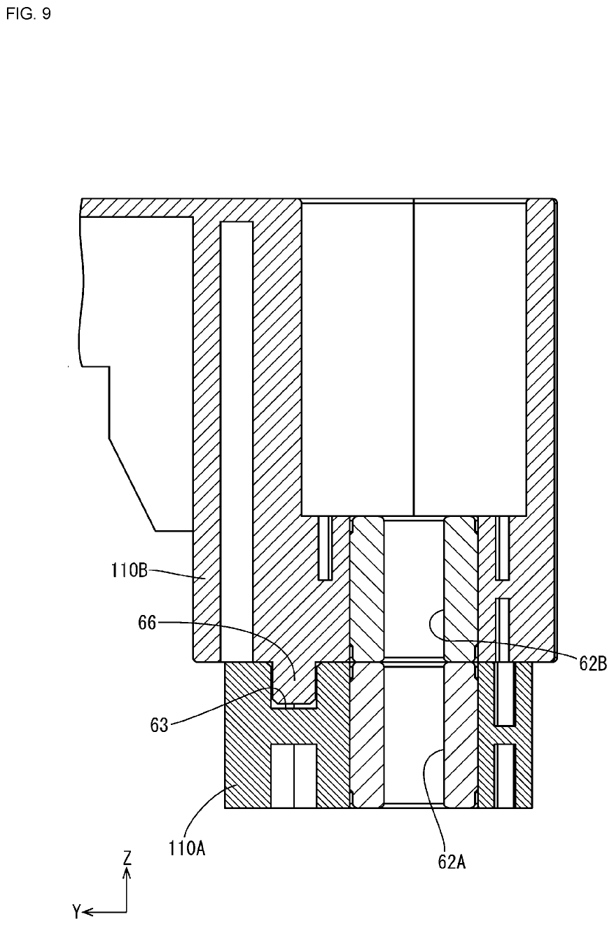

As depicted in FIG. 6, four fixing holes 62A are formed so as to vertically pass through the outer edges of the base member 110A at the front right, front left, rear right, and rear left. As depicted in FIG. 9, protrusion receiving portions 63 that are downwardly recessed from the upper surface of the base member 110A are provided at edges of the fixing holes 62A.

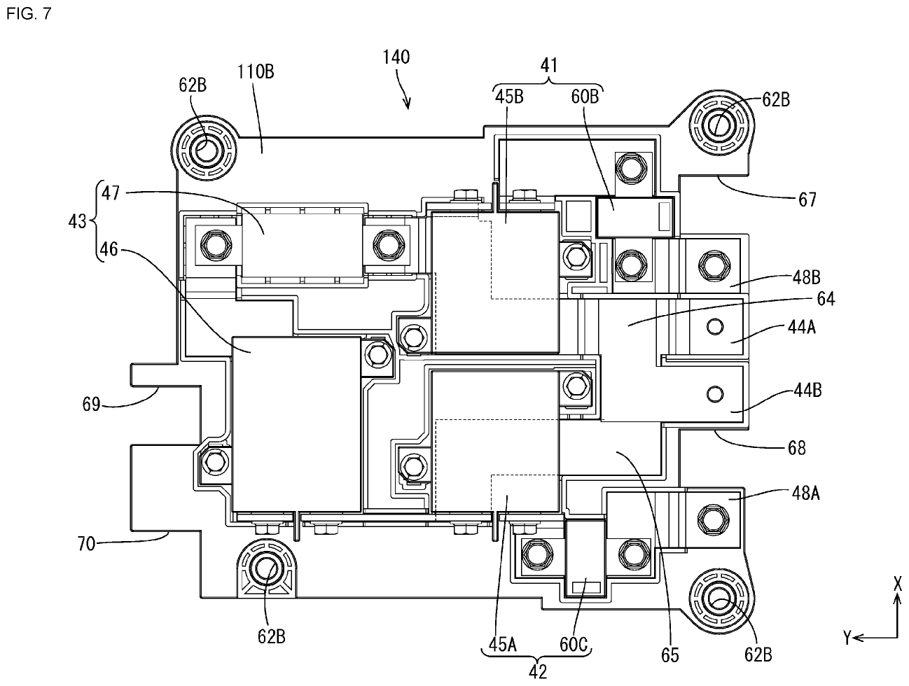

As depicted in FIG. 7, the series-parallel switching unit 140 is configured by disposing electronic components and bus bars on a base member 110B. The third conductive path 41 includes the second relay 45B and the current sensor 60B, and is disposed at the front and on the right of the base member 110B. A bus bar that is connected to the second relay 45B and is disposed below the second relay 45B serves as a fifth bus bar 64. The intermediate potential connecting portion 44B is provided at the right end of the fifth bus bar 64. A bus bar that is connected to the current sensor 60B and extends to the right serves as the connection bus bar 48B. As depicted in FIG. 8, the connection bus bar 48B extends greatly downward and is connected to the connecting portion 61B of the electrical connection unit 120 by bolting.

As depicted in FIG. 7, the fourth conductive path 42 includes a second relay 45A and a current sensor 60C, and is disposed at the rear and to the right of the base member 110B. A bus bar that is connected to the second relay 45A and disposed below the second relay 45A serves as a sixth bus bar 65. The intermediate potential connecting portion 44A is provided at the right end of the sixth bus bar 65. As depicted in FIG. 8, the sixth bus bar 65 is disposed below the fifth bus bar 64, with the sixth bus bar 65 and the fifth bus bar 64 crossing each other without making contact. That is, the sixth bus bar 65 and the fifth bus bar 64 cross each other three dimensionally in the same way as the second bus bar 50 and the fourth bus bar 52 in the first embodiment. As depicted in FIG. 7, a bus bar that is connected to the current sensor 60C and extends to the right serves as the connection bus bar 48A. As depicted in FIG. 8, the connection bus bar 48A extends greatly downward and is connected to the connecting portion 61A of the electrical connection unit 120 by bolting.

As depicted in FIG. 7, the fifth conductive path 43 includes the first relay 46 and the first fuse 47, and is disposed on the left side of the base member 110B.

As depicted in FIG. 7, four fixing holes 62B are vertically formed through the outer edge of the base member 110B at the front right, front left, rear right, and rear left. As depicted in FIG. 9, the fixing holes 62B are provided at positions corresponding to the fixing holes 62A of the base member 110A and when the base members 110A and 110B are placed over each other, the fixing holes 62A and 62B communicate with each other. A protrusion 66 that protrudes downward from the lower surface of the base member 110B is provided at the edge of each fixing hole 62B. The protrusions 66 fit into the protrusion receiving portions 63, which makes it possible to align the base members 110A and 110B. Although not illustrated, bolts are inserted through the fixing holes 62A and 62B and are fastened to bolt fastening portions inside the battery pack 1.

As depicted in FIG. 7, the base member 110B has four cutaway portions 67, 68, 69, and 70 provided so as to be inwardly recessed from the outer edge of the base member 110B. The cutaway portion 67 is disposed in front of the connection bus bar 48B. The cutaway portion 68 is disposed in front of the connection bus bar 48A. The cutaway portion 69 is arranged to the left of the first relay 46. The cutaway portion 70 is disposed to the rear of the cutaway portion 69. As depicted in FIG. 5, in a state where the electrical connection unit 120 and the series-parallel switching unit 140 have been stacked, the main positive electrode connecting portion 23, the main negative electrode connecting portion 25, and the load connecting portions 24A and 24B are disposed inside the cutaway portions 67, 68, 69, and 70. Accordingly, after stacking the electrical connection unit 120 and the series-parallel switching unit 140, by fastening bolts, it is easy to connect the main positive electrode connecting portion 23 to the main positive electrode, to connect the main negative electrode connecting portion 25 to the main negative electrode, and to connect the load connecting portions 24A and 24B to the load.

### Functions and Effects of the Second Embodiment

According to the second embodiment, the following functions and effects are obtained.

In the second embodiment, the electrical connection unit 120 and the series-parallel switching unit 140 are formed separately and are capable of being stacked.

According to the above configuration, it is possible to reduce the area occupied by the power control apparatus 110, that is, the area on a plane that is perpendicular to the axis in which the stacking direction of the electrical connection unit 120 and the series-parallel switching unit 140 extends. It is possible to install the electrical connection unit 120 and the series-parallel switching unit 140 in a vehicle or the like in a stacked state and also possible to separate only the electrical connection unit 120 and install the electrical connection unit 120 in a vehicle or the like.

According to the second embodiment, the series-parallel switching unit 140 is stacked on the electrical connection unit 120, and has the cutaway portions 67, 68, 69, and 70 provided in the insulating resin base member 110B which constructs the series-parallel switching unit 140. The electrical connection unit 120 includes the load connecting portions 24A and 24B that are connected to a load, the main positive electrode connecting portion 23 that is connected to the main positive electrode of the high-voltage battery 11, and the main negative electrode connecting portion 25 that is connected to the main negative electrode of the high-voltage battery 11, with the main positive electrode connecting portion 23, the main negative electrode connecting portion 25, and the load connecting portions 24A and 24B being disposed inside the cutaway portions 67, 68, 69, and 70.

According to the above configuration, the connecting of the power control apparatus 110 and the high-voltage battery 11 and the connecting of the power control apparatus 110 and the load can be performed after the electrical connection unit 120 and the series-parallel switching unit 140 have been stacked.

### Other Embodiments

Although the connections between the bus bars and the connections between the electronic components and the bus bars are achieved by bolting in the above embodiments, the present disclosure is not limited to this and such connections may be achieved by welding or the like.

Although the high-voltage battery 11 is composed of two cell units 14A and 14B in the above embodiments, the present disclosure is not limited to this and the high-voltage battery may be composed of three or more cell units.

1. A power control apparatus that is connected to a high-voltage battery constructed by connecting a plurality of cell units, the power control apparatus comprising:
an electrical connection unit configured to connect the high voltage battery and a load; and
a series-parallel switching unit that is connected to the plurality of cell units and the electrical connection unit and is configured to switch a connection between the plurality of cell units between series and parallel,
wherein the electrical connection unit and the series-parallel switching unit are integrated.

2. The power control apparatus according to claim 1,
further comprising a connecting bus bar for connecting the electrical connection unit and the series-parallel switching unit.

3. The power control apparatus according to claim 1,
further comprising a single base member made of insulating resin,
wherein the electrical connection unit and the series-parallel switching unit are integrally formed on the base member.

4. The power control apparatus according to claim 1,
wherein the electrical connection unit and the series-parallel switching unit are separately formed and are capable of being stacked.

5. The power control apparatus according to claim 4,
wherein the series-parallel switching unit is stacked on the electrical connection unit,
cutaway portions are formed in a base member, which is made of insulating resin and constructs the series-parallel switching unit, and
the electrical connection unit includes a load connecting portion for connecting to the load, a main positive electrode connecting portion for connecting to a main positive electrode of the high-voltage battery, and a main negative electrode connecting portion for connecting to a main negative electrode of the high-voltage battery, and
the main positive electrode connecting portion, the main negative electrode connecting portion, and the load connecting portion are disposed inside the cutaway portions.

6. The power control apparatus according to claim 1,
wherein the electrical connection unit includes a load connecting portion for connecting to the load, a main positive electrode connecting portion for connecting to a main positive electrode of the high-voltage battery, and a main negative electrode connecting portion for connecting to a main negative electrode of the high-voltage battery,
the series-parallel switching unit includes a plurality of intermediate potential connecting portions to which electrode terminals of the plurality of cell units that are not the main positive electrode and the main negative electrode are connected,
the load connecting portion is disposed on an opposite side to the main positive electrode connecting portion, the main negative electrode connecting portion, and the plurality of intermediate potential connecting portions, and
the plurality of intermediate potential connecting portions are disposed between the main positive electrode connecting portion and the main negative electrode connecting portion.

7. The power control apparatus according to claim 2,
further comprising a single base member made of insulating resin,
wherein the electrical connection unit and the series-parallel switching unit are integrally formed on the base member.

8. The power control apparatus according to claim 2, wherein the electrical connection unit and the series-parallel switching unit are separately formed and are capable of being stacked.

9. The power control apparatus according to claim 2,
wherein the electrical connection unit includes a load connecting portion for connecting to the load, a main positive electrode connecting portion for connecting to a main positive electrode of the high-voltage battery, and a main negative electrode connecting portion for connecting to a main negative electrode of the high-voltage battery,
the series-parallel switching unit includes a plurality of intermediate potential connecting portions to which electrode terminals of the plurality of cell units that are not the main positive electrode and the main negative electrode are connected,
the load connecting portion is disposed on an opposite side to the main positive electrode connecting portion, the main negative electrode connecting portion, and the plurality of intermediate potential connecting portions, and
the plurality of intermediate potential connecting portions are disposed between the main positive electrode connecting portion and the main negative electrode connecting portion.

10. The power control apparatus according to claim 3,
wherein the electrical connection unit includes a load connecting portion for connecting to the load, a main positive electrode connecting portion for connecting to a main positive electrode of the high-voltage battery, and a main negative electrode connecting portion for connecting to a main negative electrode of the high-voltage battery,
the series-parallel switching unit includes a plurality of intermediate potential connecting portions to which electrode terminals of the plurality of cell units that are not the main positive electrode and the main negative electrode are connected,
the load connecting portion is disposed on an opposite side to the main positive electrode connecting portion, the main negative electrode connecting portion, and the plurality of intermediate potential connecting portions, and
the plurality of intermediate potential connecting portions are disposed between the main positive electrode connecting portion and the main negative electrode connecting portion.

11. The power control apparatus according to claim 4,
wherein the electrical connection unit includes a load connecting portion for connecting to the load, a main positive electrode connecting portion for connecting to a main positive electrode of the high-voltage battery, and a main negative electrode connecting portion for connecting to a main negative electrode of the high-voltage battery,
the series-parallel switching unit includes a plurality of intermediate potential connecting portions to which electrode terminals of the plurality of cell units that are not the main positive electrode and the main negative electrode are connected,
the load connecting portion is disposed on an opposite side to the main positive electrode connecting portion, the main negative electrode connecting portion, and the plurality of intermediate potential connecting portions, and
the plurality of intermediate potential connecting portions are disposed between the main positive electrode connecting portion and the main negative electrode connecting portion.

12. The power control apparatus according to claim 5,
wherein the electrical connection unit includes a load connecting portion for connecting to the load, a main positive electrode connecting portion for connecting to a main positive electrode of the high-voltage battery, and a main negative electrode connecting portion for connecting to a main negative electrode of the high-voltage battery,
the series-parallel switching unit includes a plurality of intermediate potential connecting portions to which electrode terminals of the plurality of cell units that are not the main positive electrode and the main negative electrode are connected,
the load connecting portion is disposed on an opposite side to the main positive electrode connecting portion, the main negative electrode connecting portion, and the plurality of intermediate potential connecting portions, and
the plurality of intermediate potential connecting portions are disposed between the main positive electrode connecting portion and the main negative electrode connecting portion.
